(19) United States
(12) Patent Application Publication
(10) Pub. No.: US 2006/0254534 A1
(43) Pub. Date: Nov. 16, 2006

(54) Pet lead structure

(76) Inventor: Chung Hsun Lin, Taipei City (TW)

Correspondence Address: LIN, CHUNG HSUN, 9F., No. 37, Dongsing Road, Xinyi District, Taipei City, 110, TW

(21) Appl. No.: 11/128,793

(22) Filed: May 16, 2005

(51) Int. Cl. A01K 27/00

(52) U.S. Cl. 119/792

(57) ABSTRACT

An improving pet lead structure comprises a base, a hooking body and a body carrier, wherein the base is made of two plates are connected together from its side surfaces. A central slot is formed on the two plates of the base. The central slot is extended from its both sides to form channel-shaped holes. At least one decoration is inserted into the holes of the two plates, and pins or other objects with the similar function are used to attached the decoration to the two plates. The hooking body comprises a rectangular-shaped body that can be inserted into the channel-shaped holes of the base, wherein an attaching ring is attached to a top portion of the hooking body. A strap and a hooking member are used to attach onto the attaching ring. The body carrier which is a long structure with a softness character is inserted into a gap between the two plates. The body carrier is then inserted into the hooking body repeatedly and its both ends are connected together to form a neck loop and a chest loop, wherein the neck loop and the chest loop are used for wrapping around an body of a pet. Sizes of diameters of the neck loop and the chest loop can be adjusted by stretching through the gap of the two plates according to the size of the pet. Utilization of the decoration within the plates increases the sense of virtual beauty of the base of the pet lead.

### BACKGROUND OF THE INVENTION

1. Field of Invention

The present invention relates generally to an improving pet lead. More particularly, the present invention relates to a pet lead structure that is convenient to wear, easy to stretch the strap of the pet lead, and the sense of virtual beauty increased by combining the pet lead structure with the decoration.

2. Description of the Related Art

The prior art of pet lead structure shown in FIG. 1, wherein a body carrier 5 is cross-wrapped to form a circular-shaped neck portion 51, and both ends of the circular-shaped neck portion 51 are then wrapped around a chest position of a pet in accompanying with an adjusting structure 53 to form a circular-shaped chest portion 52 along the back side of the pet. Wherein the adjusting structure 53 is used to adjust a size of diameter of the circular-shaped chest portion 52. One side of the body carrier 5 is closed to sides of front foot of the pet. The circular-shaped neck portion 51 and the circular-shaped chest portion 52 are cross-wrapped and inserted into a connecting hole 541 of a pulling belt 54. The circular-shaped neck portion 51 and the circular-shaped chest portion 52 are stretched freely through the connecting hole 541. One end of the pulling belt 54 has a connecting ring 542 to allow a strap 6 to be hooked onto the connecting hole 541 through a hooking body 61. However, the circular-shaped neck portion 51 and the circular-shaped chest portion 52 are formed by wrapping the above-mentioned body carrier 5 around the pet. The circular-shaped neck portion 51 and the circular-shaped chest portion 52 both move at the same time in the connecting hole 541, which make the wrapping combination and the stretching adjustment inconvenient.

FIGS. 2 and 3 show an improvement of the pet lead, ROC Patent No 375874 teaches an improving pet lead structure, wherein a connecting base is 4 made of resistible material and has a rectangular-shaped slot 411. A central section of the rectangular-shaped slot 411 is enlarged to form hole 41 so that a rectangular-shaped hooking ring 2 can be fitted into the slot 411 and the hole 41. The connecting base 4 has four slots, 42-45, locating at the four corners of the connecting base 4. An attaching ring 21 is formed on a top portion of the hooking ring 2 to be hooked with a strap. A body carrier 3 has a female connector 31 on one its end and a male connector 32 on its another end, and an adjusting ring 33 is located on the body carrier 3. Both ends of the body carrier 3 are inserted into the hooking ring 2 and then are inserted into the four slots 42-45 of the connecting base 4. Once the body carrier 3 comes through the slots 42-45, its both ends of the body carrier 3 are then connected together through the female connector 32 and the male connector 31. A neck loop 304 is thus formed to wrap on the neck of a pet and a chest loop 305 is formed to wrap around the back of the pet. This kind of design, the body carrier 3 required to insert into the hooking ring 2 and the four slots 42-45 of the connecting base 4. Since the shape of the slots 42-45 is rectangular, the body carrier 3 would have a lot of fiction through the slots 42-45, thus the size of the diameters of the neck loop and the chest loop could not be adjusted easily. Therefore, the utility of the pet lead structure of this kind of design is not convenient.

Therefore, it is an object of the present invention to provide an improving pet lead structure that can overcome those prior art's problems.

### SUMMARY OF THE INVENTION

It is an object of the present invention to provide an improving structure of a pet lead. A base of the present invention is made of two plates attaching together from their side surfaces with a connecting part. The base comprises a central slot, which extends from its both sides to form channel-shaped holes, and a hooking ring can be fitted into the central slot and the channel holes. The shape of the hooking ring is not limited to one type, other shapes such as a circular shape or a rectangular shape all can be utilized. An attaching ring is formed on a top of the hooking ring to allow a strap to be hooked on. A body carrier is fitted in between the gap of the two plates of the base and the hooking ring repeatedly to form a neck loop and chest loop. The neck loop and the chest loop are used to lead the pet and control its movement. It is another objective of the present invention to improve a pet lead that is comfortable to the pet. Therefore, it is a reason why the body carrier is attached in between the plates of the base in order to form the loops because the sizes of the neck loop and the chest loop can be then easily adjusted according to the size of the pet. It is another objective of the present invention to increase the virtual sense of beauty of the pet lead by attaching at least one decoration in between the plates. The decoration is fixed onto the plates with the pins

Both the forgoing general description and the flowing detailed description are exemplary and explanatory only and are no restrictive of the invention, as claimed.

### BRIEF DESCRIPTION OF THE DRAWING

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is a perspective view of a traditional structure of a pet lead;

FIG. 2 is an assembled view of another traditional structure of a pet lead;

FIG. 3 is a perspective view of another traditional structure of a pet lead depicted in FIG. 2;

FIG. 4 is an assembled view of a pet lead in accordance with a preferred embodiment of the present invention.

FIG. 5 is a 3-dimentional view of the pet lead in accordance with the preferred embodiment of the present invention.

FIG. 6 is a cross-sectional view of a base of the pet lead in accordance with the preferred embodiment of the present invention.

FIG. 7 is a 3-dimentional view of the pet lead operating on a dog in accordance with the preferred embodiment of the present invention

FIG. 8 is a 3-dimentional view of a pet lead in accordance with another preferred embodiment of the present invention.

FIG. 9 is a 3-dimentional view of the pet lead operating on a dog in accordance with the preferred embodiment of the present invention.

### DESCRIPTION OF TH PREFERRED EMBODIMENTS

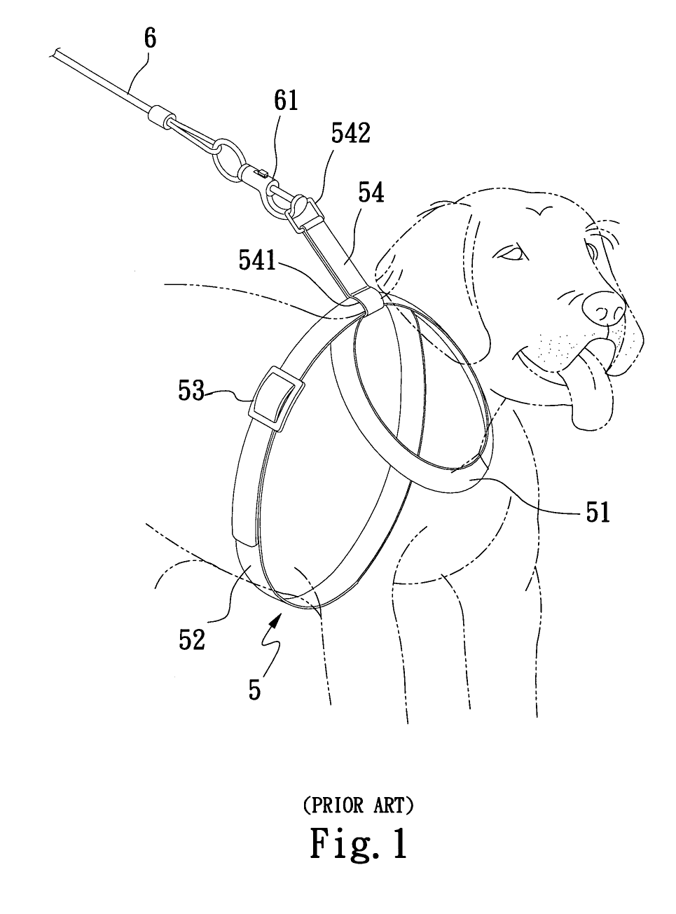

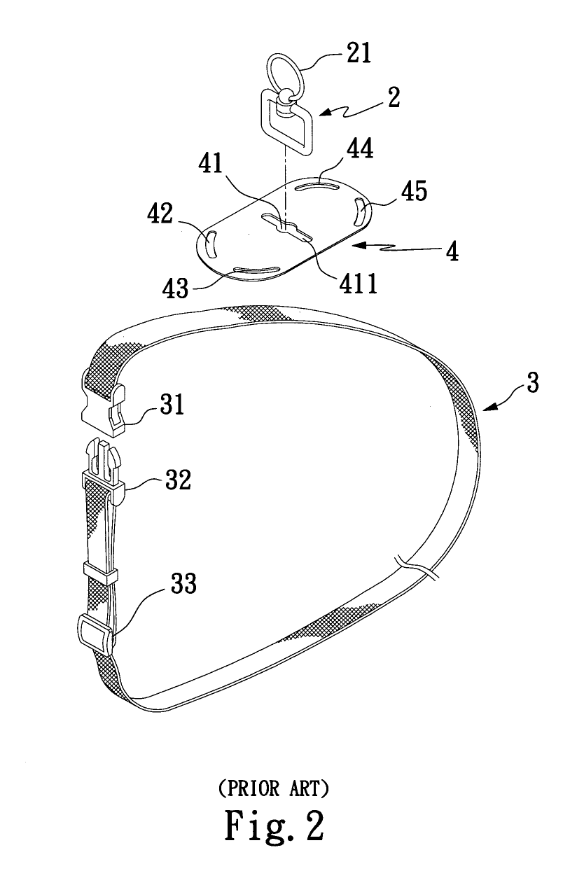

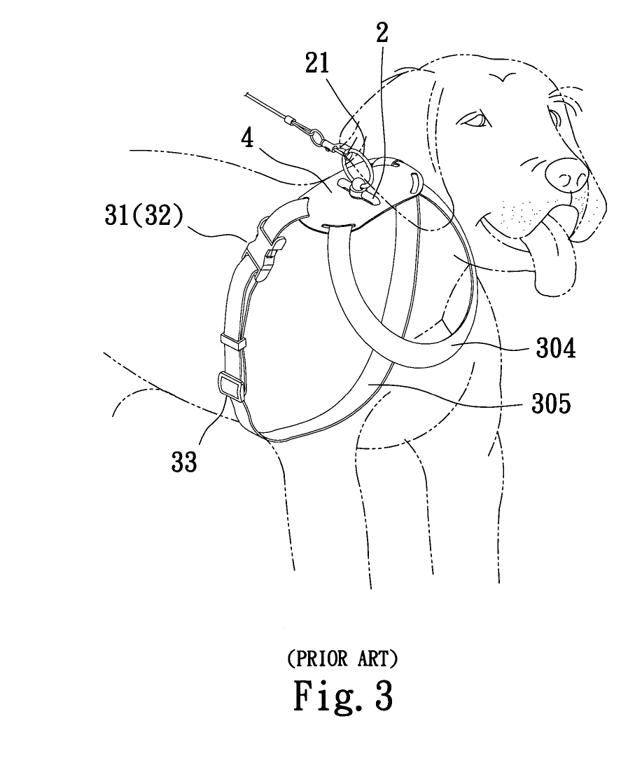

FIGS. 1, 2 and 3 illustrate the traditional pet lead structures that contain the disadvantage of difficult adjusting the neck belt.

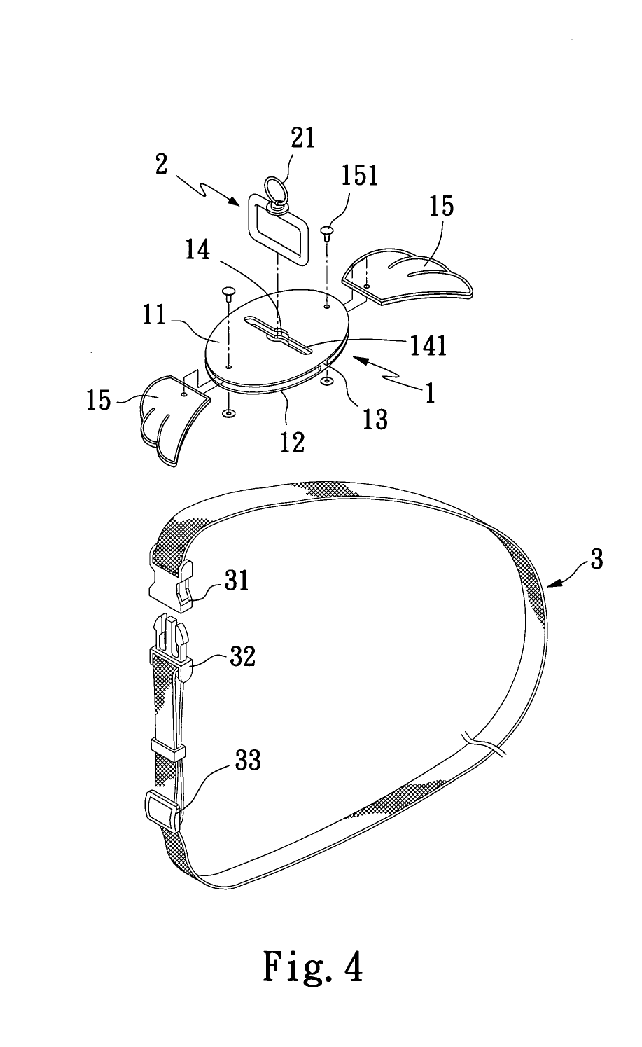

FIG. 4 shows an assembled view of a pet lead in accordance with a preferred embodiment of the present invention. Refer to FIG. 4, the structure of the pet lead comprises a base 1, a hooking ring 2 and a body carrier 3, wherein the base 1 is made of two piece of plates connecting together by a connecting part 13. A suitable gap is formed in between a first plate 11 and a second plate 12, wherein the two plates 11 and 12 are connected together on their side surfaces by the connecting part 13. A central slot 14 which is formed on the first plate 11 and the second plate 12 is extended from its both sides to form channel-shaped holes 141. A hooking ring 2 comprises a rectangular body and an attaching ring 21, which is attached to a top portion of the rectangular body, is fitted into the channel-shaped holes 141. The gap between the first plate 11 and the second plate 12 can fit at least one decoration 15, wherein the decoration 15 is attached to the plates 11 and 12 by pins 151. However, the connection between the decoration 15 and the plates 11 and 12 is not limited to the usage of the pins, other objects with the similar function can be utilized. A body carrier 3 which is a long soft structure comprises an adjusting buckle 33 and a female connector 31 and male connector 32 locating at each end of the body carrier 3.

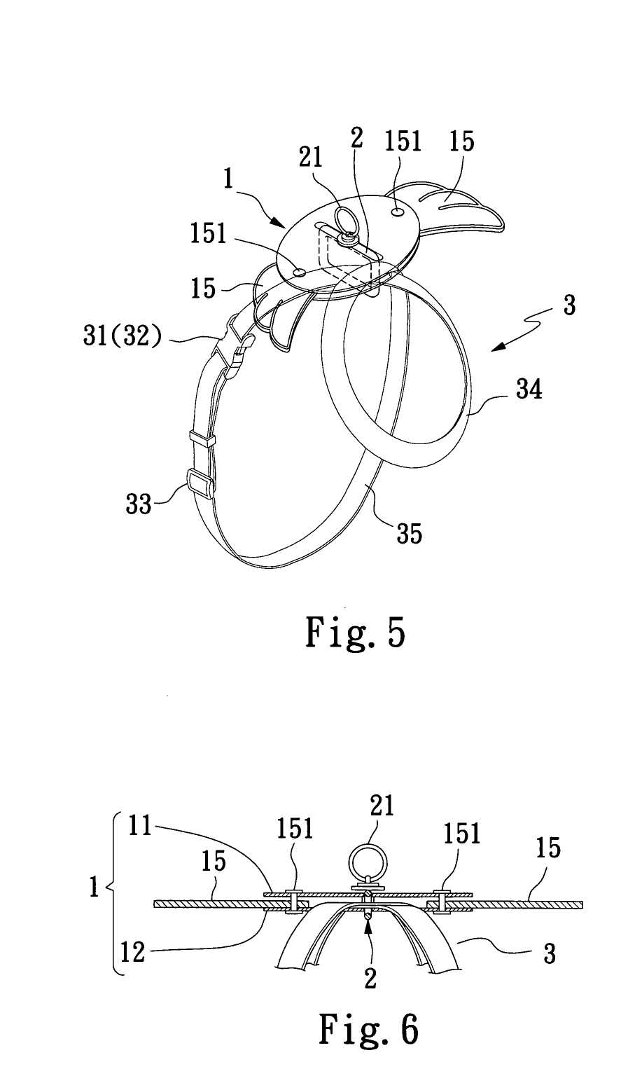

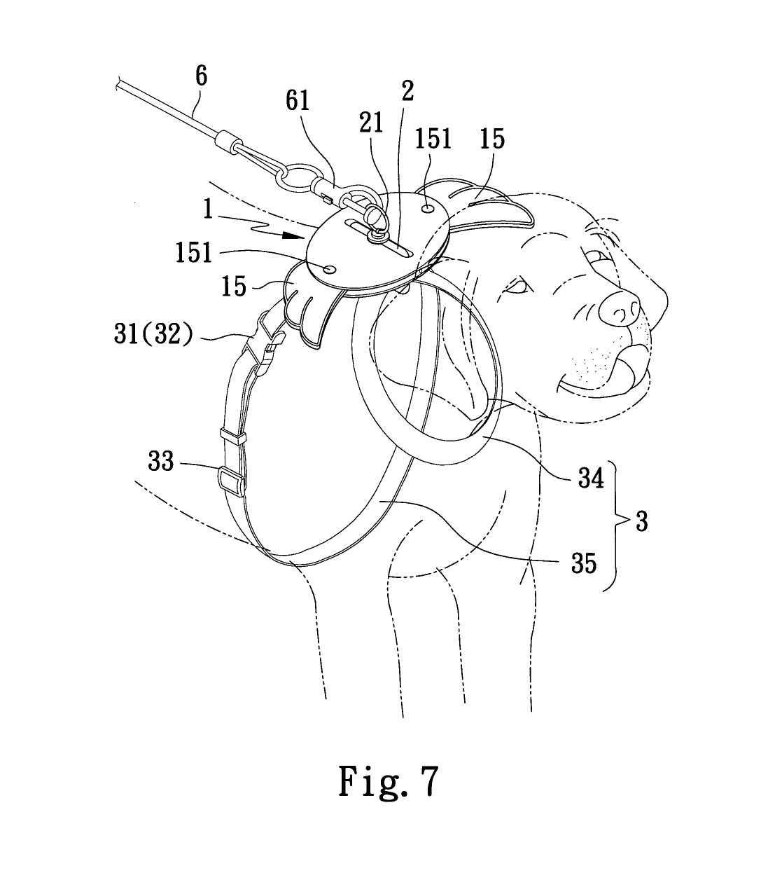

FIG. 5 is a 3-dimentional view of the pet lead in accordance with the preferred embodiment of the present invention. FIG. 6, a cross-sectional view of a base of the pet lead in accordance with the preferred embodiment of the present invention, and FIG. 7, a 3-dimentional view of the pet lead operating on a dog in accordance with the preferred embodiment of the present invention, are referred together in corresponding with FIG. 5 to have better understanding of the preferred embodiment of the present invention. The hooking ring 2 is fitted into the channel-shaped holes 141 and the attaching ring 21 is exposed outside a top surface of the base 1. The body carrier 3 is inserted into the gap between the first plate 11 and the second plate 112 repeatedly to form a neck loop 34 and a chest loop 35. Utilizing the adjusting buckle 33 to find suitable diameters of the neck loop 34 and the chest loop 35 in accordance with the size of the pet. Once the diameters of the neck loop 34 and the chest loop 35 are adjusted comfortably for the pet, the female connector 31 and the male connector 32 are buckled up. A strap 6 is attached to a hooking member 61, which the hooking member 61 is then hooked into the attaching ring 21 so that the pet owner can utilize the strap 6 to lead the pet.

The body carrier 3 is inserted freely into the gap mentioned above between the first plate 11 and the second plate 12 to from the neck loop 34 and the chest loop 35, and the body carrier 3 is then attached to the hooking ring 2. This design of the present invention not only achieves the object of adjusting the neck loop 34 and the chest loop 35 according to the pet's body size, it also achieves the object of the present invention of increasing the sense of virtual beauty by combining the different decorations 15 with the base 1.

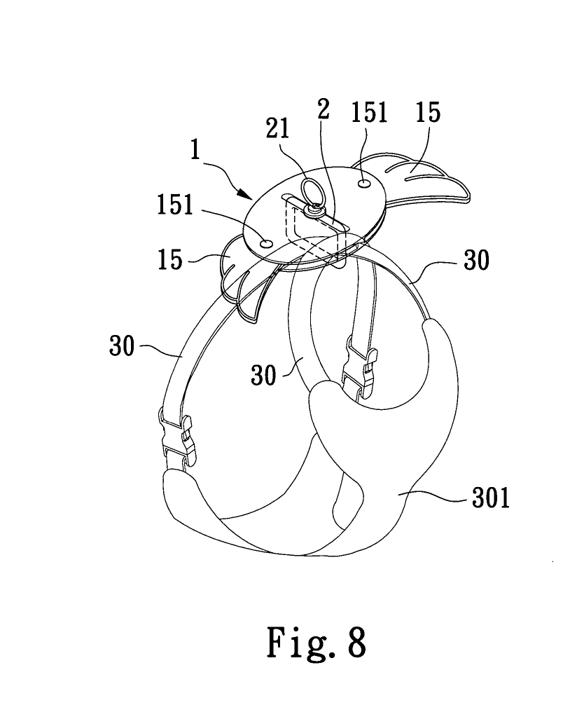

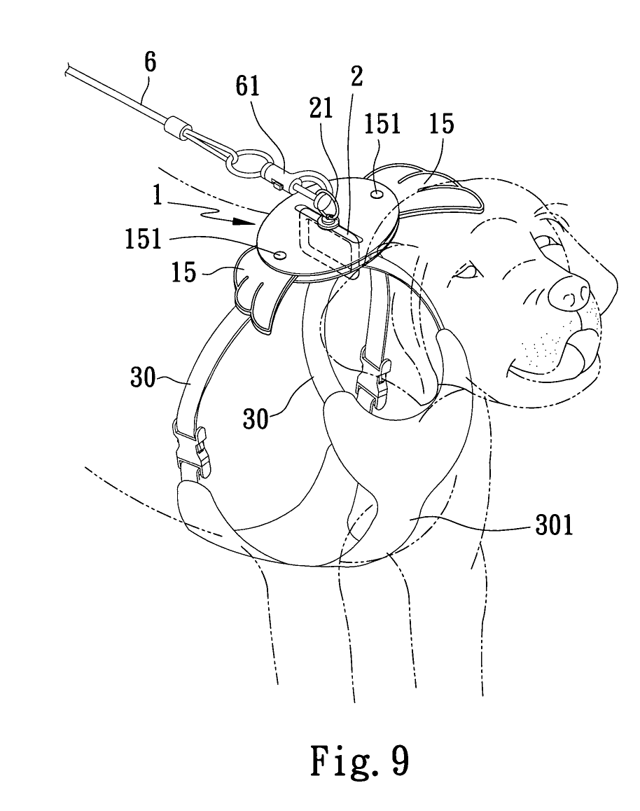

FIG. 8 is a 3-dimentional view of a pet lead in accordance with another preferred embodiment of the present invention. FIG. 9 is a 3-dimentional view of the pet lead operating on a dog in accordance with the preferred embodiment of the present invention. From both drawings, ends of two body carriers 30 are connected to both sides of an I-shaped chest cover 301. The body carriers 30 are cross-connected and then inserted into a gap between a first plate 11 and a second plate 12, and the body carriers are attached to a hooking ring 2. Other ends of the body carriers 30 are connected to the I-shaped chest cover 301 to form two loops that are used to wrap around the neck and the chest of a pet. The above-mentioned embodiments of the present invention provide an improving of a pet lead's structure. Wherein the objects of the present invention are not only to provide an adjustable and comfortable pet lead for the pet owner and the pet, it also achieves to increase the sense of virtual beauty of the pet lead by combining the decorations together with the base of the pet lead. Therefore, the present invention achieves the objects of the utilization, inventive and improvement of the industrialization.

While the invention has been described by the way of examples and in terms of a preferred embedment, it is to be understood that the invention need not be limited to the disclosed embodiment. On the contrary, it is intended to cover various modifications and similar arrangements included within the spirit and the scope of the appended claims. The scope of which should be accorded with the broadest interpretation so as to encompass all such modifications and similar structures.

What is claimed is:

1. An improving structure of a pet lead, comprising:
a base, wherein two plates are connected together on their side surfaces with a connecting part, a suitable gap is formed in between the two plates, and a central slot is formed in the two plates and the central slots is extended on its both side to form channel-shaped holes, a plurality of decorations can be inserted into the gap of the two plates;
a hooking body, wherein the hooking boy is inserted into the channel-shaped holes and a attaching ring is attached to a top portion of the hooking body, wherein the attaching ring is exposed outside the top portion of the hooking body, and a strap and a hooking member are attached to the attaching ring;
a body carrier has a character of softness, wherein the body carrier is inserted into the gap between the two plates repeatedly to from a neck loop and a chest loop, wherein both ends of the body carrier are connected together.

2. The structure of claim 1, wherein the connection between the ends of the body carrier is based on one end of the body carrier has a female connector and the other end has a male connector.

3. The structure of claim 1, wherein the body carrier has an adjusting buckle to adjust a length of the body carrier in order to alter diameters of the neck loop and the chest loop.

4. The structure of claim 1, wherein ends of the body carrier and another body carrier are connected to both sides of an I-shaped chest cover, the both body carriers are cross-inserted into the gap between the first plate and the second plate, the body carriers are attached to the hooking body and are then connected to another ends of the chest cover in order to form two loops, wherein the two loops are used for wrapping a neck and a chest of a pet.
